(19) United States
(12) Patent Application Publication
(10) Pub. No.: US 2003/0153312 A1
(43) Pub. Date: Aug. 14, 2003

(54) Integrated smart local wireless spread spectrum communication system

(75) Inventors: Yung-Ting Lee, Taipei (TW); Yuan-Chung Wu, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry, Taipei (TW)

(21) Appl. No.: 10/067,897

(22) Filed: Feb. 8, 2002

(51) Int. Cl. H04Q 7/20

(52) U.S. Cl. 455/436; 455/456

(57) ABSTRACT

An integrated smart local wireless spread spectrum communication system is disclosed. Smart antennas of the base stations are used to detect the movement of the users. Furthermore, spread spectrum communication technology is used to increase the number of available channels. The signal strength received from the wireless communication unit is used to predict the movement of the communication units, and thus a handoff process can be prepared in advance as the wireless communication unit is in an overlap area between two cells.

### BACKGROUND OF THE INVENTION

1. Field of the Invention

The present invention relates to a communication system, and more particularly to an integrated smart local wireless spread spectrum communication system.

2. Description of Prior Art

Currently, the use of local wireless communication system is restricted by its limited channel numbers, and thus the number of customer is difficult to increase. Moreover, if it is desired to track the movement of a user within the communication system, the transmitting power of the base station must be increased greatly for tracing the local position of the user. Accordingly, the system becomes more complex. Alternatively, a GPS system (global positioning system) can be used for positioning a user. However, it is required to launch several lower orbit satellites, and this will result in a high cost and further requiring purchasing some related software and database. Therefore, the current local wireless communication system still has many defects to be eliminated.

### SUMMARY OF THE INVENTION

Accordingly, the primary object of the present invention is to provide an integrated smart local wireless spread spectrum communication system, which employs smart antennas to detect the movement of a user and increase the available channel number so as to increase the number of customers.

Another object of the present invention is to provide an integrated smart local wireless spread spectrum communication system, which is capable of providing a local positioning function, saving the power consumption of the base station, and reducing the system complexity.

A further object of the present invention is to provide an integrated smart local wireless spread spectrum communication system, wherein the unlicensed 2.4 GHz band is used so that the cost of communication is low.

To achieve above object, the integrated smart local wireless spread spectrum communication system in accordance with the present invention includes: at least one mobile wireless communication unit; at least one first base station and one second base station, each providing a cell and having at least one smart antenna array, so that the mobile wireless communication unit in a cell can communicates with a communication device via the base station; and a central control unit for controlling data exchange between the first base station and second base station, and storing user data of the mobile wireless communication unit. In the cell, communication band is divided into a plurality of channels. The first base station and the second base station trace the mobile wireless communication unit by their antennas, respectively, and signal strength of the mobile wireless communication unit received by the antennas are used to determine a moving direction of the mobile wireless communication units. When the mobile wireless communication unit moves from the first base station towards the second base station, the central control unit notifies the second base station, so that the second base station can prepare to perform a handoff process in advance.

The various objects and advantages of the present invention will be more readily understood from the following detailed description when read in conjunction with the appended drawing.

### BRIEF DESCRIPTION OF THE DRAWINGS

FIG. 1 is a systematic structure of the present invention.

FIG. 2 is a flowchart showing the user's wireless communication cells of the present invention.

FIG. 3 is a flowchart of the disconnection process of the present invention.

FIG. 4 is a flowchart of the handoff process of the present invention.

### DETAILED DESCRIPTION OF THE PREFERRED EMBODIMENTS

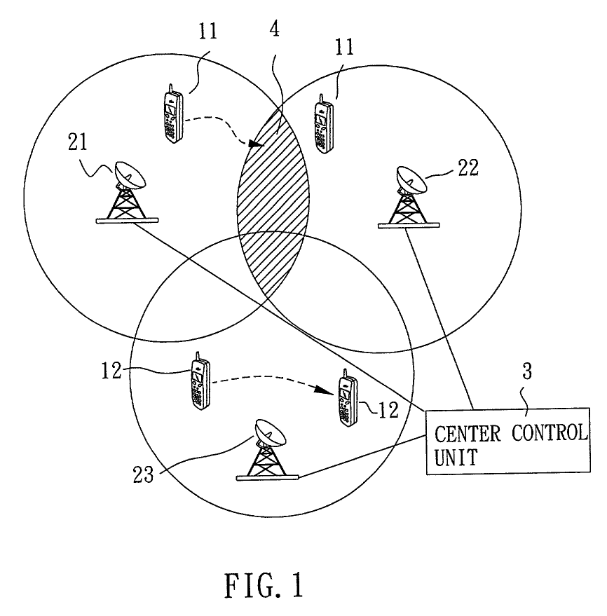

In one preferred embodiment of the present invention, a 2.4 GHz system is given as an example in which a mobile phone moves in various base stations. With reference to FIG. 1, there is shown a systematic construction of the present invention, which includes wireless communication units 11 and 12, base stations 21, 22 and 23 and a central control unit 3.

In this embodiment, the wireless communication units 11 and 12 are mobile phones. Alternatively, the personal digital assistant (PDA), notebook computer and other personal portable devices may be employed. Each of the base stations 21, 22 and 23 provides a wireless coverage, known as a cell. Therefore, a wireless communication unit 11 or 12 can be communicated with the other wireless communication unit 11 or 12 in its cell for transferring voice or data signal. Each of the base stations 21, 22 and 23 has a smart antenna array for tracking the movement of the wireless communication unit 11 or 12 in a cell. Furthermore, the communication bandwidth of a cell is divided into a plurality of channels by the spread spectrum technology. Different cells are distinguished by employing different direct sequence spread spectrums (DSSS), so that adjacent cells can use the same channels to perform wireless communications for different wireless communication units 11 and 12. Between two base stations, for example, base stations 21 and 22, there is provided an overlap area 4. The central control unit 3 serves for data exchange among different base stations 21, 22 and 23, and storage of user data. Therefore, a wide area wireless communication environment is constructed.

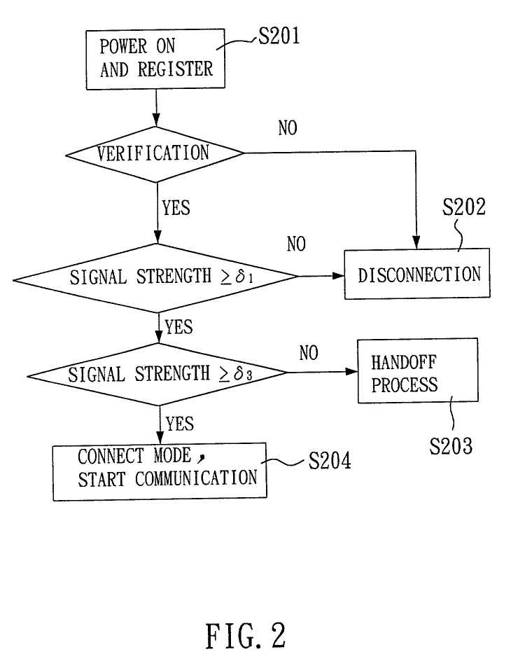

FIG. 2 is a flow diagram illustrating that a user moves in cells. When a user powers on the wireless communication unit 11, the wireless communication unit 11 registers to the central control unit 3 through the base station 21 (step S201). If the registration is successful, the base station 21 uses its smart antenna to detect the signal strength of the wireless communication unit 11. If the registration is failed, the central control unit 3 interrupts the communication of the wireless communication unit 11 through the base station 21 (step S202). When the base station 21 detects the signal strength of the wireless communication unit 11, the signal strength is compared with a predetermined signal strength δ₁. If the detected signal strength is larger than δ₁, the detected signal strength is further compared with a predetermined signal strength δ₃. If the detected signal strength is smaller than δ₁, the communication of the wireless communication unit 11 is interrupted (step S202). If the detected signal strength of the wireless communication unit 11 is still larger than δ₃, a connection mode is entered to start a communication (step S204); otherwise, an handoff process is performed for the wireless communication unit 11 (step S203).

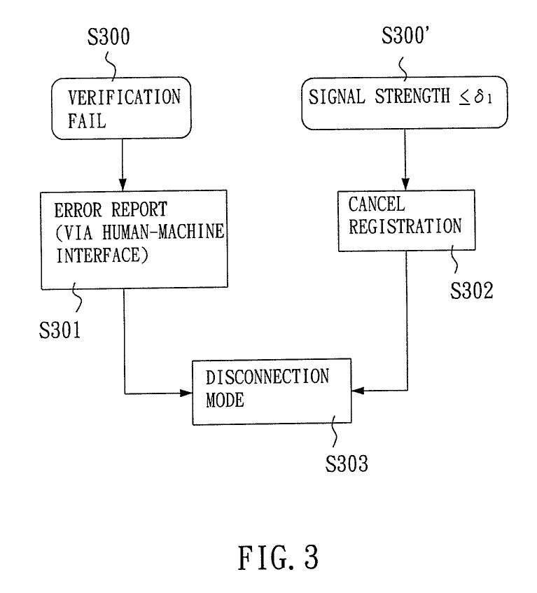

FIG. 3 shows the flowchart of the interruption process. If a verification is failed (step S300), the base station 21 sends an error message of no system service to the wireless communication unit 11 (step 301) and disconnects the connection to the wireless communication unit 11 (step S303′). When the base station 21 detects that the signal strength of the wireless communication unit 11 is smaller than δ₁ (for example, when the user turns off the mobile phone or the user is out of the cell), the base station 21 cancels the registration (step S302), and the connection to the wireless communication unit 11 is disconnected (step S303).

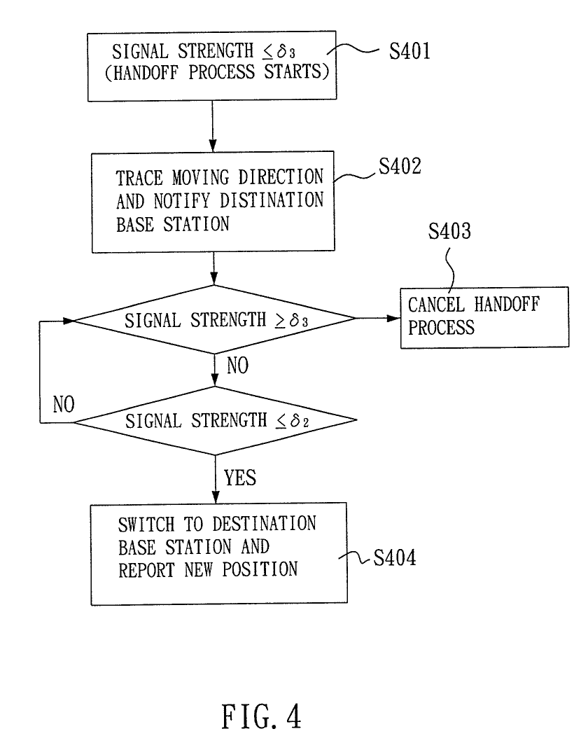

FIG. 4 shows the flowchart of the handoff process in accordance with the present invention. When a user having the wireless communication unit 11 moves from a position nearest to the base station 21 towards the base station 22, and if the smart antenna of the base station 21 detects that the signal strength of the wireless communication unit 11 is smaller than δ₃, the base station 21 performs a handoff process to the wireless communication unit 11 (step S401). The base station 21 uses the smart antenna to trace the wireless communication unit 11. Since the smart antenna traces only in one direction and power is transmitted from the base station 21, the power is greatly reduced, in comparison with that of the conventional multi-direction antenna.

As the base station 21 keeps tracing the wireless communication unit 11, the moving direction of the wireless communication unit 11 can be predicted, and thus an adjacent destination base station 22 can be notified of the moving direction (step S402). Therefore, the base station 22 starts to detect the signal strength of the wireless communication unit 11. At this moment, if the user holding the wireless communication unit 11 moves back to the base station 21, the base station 21 detects that the signal strength of the wireless communication unit 11 is larger than δ₃, and thus cancels the handoff process (step S403).

If the user keeps moving towards the base station 22 and arrives at the overlap area 4 between the base stations 21 and 22, the base station 21 detects that the signal strength of the wireless communication unit 11 is smaller than δ₂. Then, the control is switched from the base station 21 to the destination base station 22, and the corresponding services for the wireless communication unit 11 are then provided by the base station 22. Moreover, the position of the wireless communication unit 11 is reported to the central control unit 3 (step S404). The base station 22 is responsible for detecting the wireless communication unit 11. After detecting such, the received signal strength of the wireless communication unit 11 in switching is used as a priority for arranging channels. If the received signal strength is strong, the wireless communication unit 11 has a higher priority. If the base station 21 detects that the signal strength of the wireless communication unit 11 is larger than δ₂, it represents that the user still moves around in the overlap area 4. Then, the wireless communication unit 11 is kept in detecting and the detected signal strength is compared with the predetermined signal strengths δ₂ and δ₃.

In view of the foregoing, it is appreciated that in the present invention, the movement of the user is detected through smart antennas and the moving direction of the user can be predicted. The smart antenna transmits power toward the detected direction for reducing the loss of power. The base station in the direction is notified of performing a handoff process. Furthermore, a priority process is used for designating a channel to the detected wireless communication unit, thereby improving the quality of service and decreasing the possibility of interruption. Moreover, the spread spectrum technology is used for increasing the number of available communication channels.

Although the present invention has been explained in relation to its preferred embodiment, it is to be understood that many other possible modifications and variations can be made without departing from the spirit and scope of the invention as hereinafter claimed.

What is claimed is:

1. An integrated smart local wireless spread spectrum communication system comprising:
at least one mobile wireless communication unit;
at least one first base station and one second base station, each providing a cell and having at least one smart antenna array, so that the mobile wireless communication unit in a cell can communicates with a communication device via the base station; and
a central control unit for controlling data exchange between the first base station and second base station, and storing user data of the mobile wireless communication unit communication unit;
wherein, in the cell, communication band is divided into a plurality of channels; the first base station and the second base station trace the mobile wireless communication unit by their antennas, respectively, and signal strength of the mobile wireless communication unit received by the antennas are used to determine a moving direction of the mobile wireless communication units, whereby, when the mobile wireless communication unit moves from the first base station towards the second base station, the central control unit notifies the second base station, so that the second base station can prepare to perform a handoff process in advance.

2. The integrated smart local wireless spread spectrum communication system as claimed in claim 1, wherein the first and second base stations determine the signal strength of the mobile wireless communication unit through a first specific value, a second specific value, and a third specific value; the third specific value is larger than the second specific value; the second specific value is larger than the first specific value; when the first base station detects that the mobile wireless communication unit moves from the first base station towards the second base station and the signal strength received by the first base station is smaller than the third specific value, the first base station performs a handoff process to the mobile wireless communication unit.

3. The integrated smart local wireless spread spectrum communication system as claimed in claim 1, wherein the received signal strengths of the first base station and second base station are used to arrange priorities of the channels.

4. The integrated smart local wireless spread spectrum communication system as claimed in claim 1, wherein different cells are distinguished by employing different direct sequence spread spectrums, so that adjacent cells can use the same channels to perform wireless communications for different wireless communication units.

5. The integrated smart local wireless spread spectrum communication system as claimed in claim 1, wherein the communication band is 2.4 GHz unlicensed band.

6. The integrated smart local wireless spread spectrum communication system as claimed in claim 1, wherein the antennas of the first base station and second base station are smart antennas.

7. The integrated smart local wireless spread spectrum communication system as claimed in claim 2, wherein when the received signal strength is smaller than the first specific value, the first base station disconnects its connection to the mobile wireless communication unit.

8. The integrated smart local wireless spread spectrum communication system as claimed in claim 2, wherein when the received signal strength is larger than the third specific value, the first base station connects the first mobile wireless communication unit for communication.

9. The integrated smart local wireless spread spectrum communication system as claimed in claim 2, wherein when the received signal strength is smaller than the second specific value and larger than the first specific value, the first base station switches control to the second base station, and a new position of the wireless communication unit is reported to the central control unit.
